(19) United States
(12) Patent Application Publication
(10) Pub. No.: US 2024/0379944 A1
(43) Pub. Date: Nov. 14, 2024

(54) NEGATIVE ACTIVE MATERIAL AND RECHARGEABLE LITHIUM BATTERY INCLUDING SAME

(71) Applicants: SAMSUNG SDI CO., LTD., Yongin-si (KR); University-Industry Cooperation Group of Kyung Hee University, Yongin-si (JP)

(72) Inventors: Ilyoung CHOI, Yongin-si (KR); Min-Sik PARK, Yongin-si (KR); Taehee KIM, Yongin-si (KR); Sungmin PARK, Yongin-si (KR); Deok-Hyun KIM, Yongin-si (KR); Jaehou NAH, Yongin-si (KR); Youngugk KIM, Yongin-si (KR); Joo Hyeong SUH, Yongin-si (KR)

(21) Appl. No.: 18/380,353

(22) Filed: Oct. 16, 2023

(30) Foreign Application Priority Data
May 10, 2023 (KR) 10-2023-0060642

(51) Int. Cl. H01M 4/36; C01B 32/21; C01B 32/914; C01B 32/921; H01M 4/587; H01M 10/0525; H01M 4/02

(52) U.S. Cl. CPC H01M 4/366; C01B 32/21; C01B 32/914; C01B 32/921; H01M 4/587; H01M 10/0525; C01B 2204/22; C01P 2006/40; H01M 2004/027

(57) ABSTRACT

A negative active material and a rechargeable lithium battery including the negative active material, the negative active material includes a core including a carbon material; and a metal carbide on a surface of the core, wherein the metal of the metal carbide is Ti, Mo, Fe, Nb, Ta, W, or V.

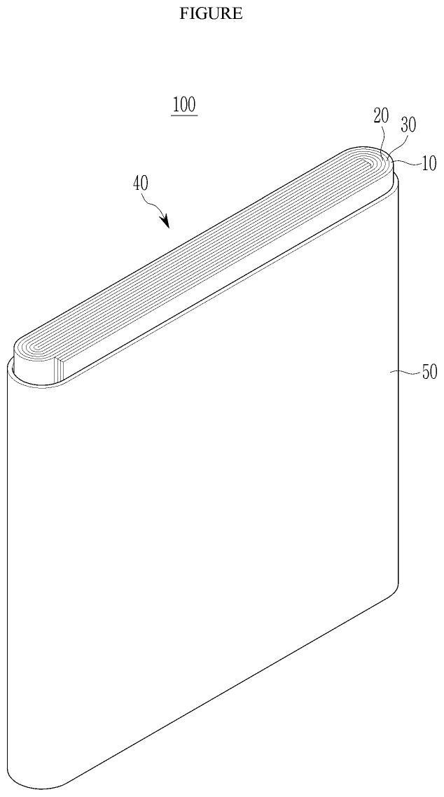

### CROSS-REFERENCE TO RELATED APPLICATION

This application claims priority to and the benefit of Korean Patent Application No. 10-2023-0060642 filed in the Korean Intellectual Property Office on May 10, 2023, the entire contents of which are incorporated herein by reference.

### BACKGROUND

### 1. Field

Embodiments relate to negative active materials and rechargeable lithium batteries including the same.

### 2. Description of the Related Art

In order to cope with climate changes, as automobile fuel efficiency regulations and introduction of electrical vehicles are being mandatory worldwide, the demand for the electric vehicles is gradually increasing.

### SUMMARY

The embodiments may be realized by providing a negative active material including a core including a carbon material; and a metal carbide on a surface of the core, wherein the metal of the metal carbide is Ti, Mo, Fe, Nb, Ta, W, or V.

The metal carbide may be represented by Chemical Formula 1:

MₓC_{y} [Chemical Formula 1]

in Chemical Formula 1, 1≤x≤2 and 1≤y≤3, and M may be Ti, Mo, Fe, Nb, Ta, W, or V.

The metal carbide may be TiC, Mo₂C, Fe₂C, NbC, TaC, WC, VC, or a combination thereof.

The metal carbide may be included in the negative active material in an amount of about 0.5 wt % to about 20 wt %, based on a total weight of the negative active material.

The metal carbide may be included in the negative active material in an amount of about 0.5 wt % to about 10 wt %, based on a total weight of the negative active material.

The core may be included in the negative active material in an amount of about 80 wt % to about 99.5 wt %, based on a total weight of the negative active material.

The carbon material may be crystalline carbon, amorphous carbon, or a combination thereof.

The carbon material may be crystalline carbon.

The negative active material may be prepared by mixing the carbon material and a carbon precursor in a solvent to prepare a primary mixture; mixing the primary mixture and a metal precursor to prepare a secondary mixture; and heat-treating the secondary mixture.

The carbon precursor may be glucose, sucrose, polyvinylpyrrolidone, polyvinyl alcohol, polyethylene, or a combination thereof.

The metal precursor may be a metal alkoxide, a metal acetate, a metal hydroxide, or a combination thereof.

The heat-treating may be performed under an atmosphere of nitrogen gas, argon gas, or a combination thereof.

The heat-treating may be performed at about 500° C. to about 1,400° C.

The embodiments may be realized by providing a rechargeable lithium battery including a negative electrode including the negative active material according to an embodiment; a positive electrode; and an electrolyte.

### BRIEF DESCRIPTION OF THE DRAWING

Features will be apparent to those of skill in the art by describing in detail exemplary embodiments with reference to the attached drawing in which:

The FIGURE is a schematic view of a rechargeable lithium battery according to some embodiments.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing FIGURE, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

The terminology used herein is used to describe embodiments only, and is not intended to limit the present disclosure. The singular expression includes the plural expression unless the context clearly dictates otherwise.

As used herein, “a combination thereof” refers to a mixture, a laminate, a composite, a copolymer, an alloy, a blend, a reaction product, and the like of constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

Throughout the present specification, unless explicitly described to the contrary, the word “comprise” and variations such as “comprises” or “comprising”, will be understood to imply the inclusion of stated elements but not the exclusion of any other elements.

In addition, the terms “about,” “substantially,” and the like used throughout the present specification are used as meanings at or close to the numerical values when manufacturing and material tolerances inherent in the stated meaning are presented, and in order to facilitate the understanding of this application, exact or absolute figures are used to prevent undue exploitation by unscrupulous infringers of the disclosure.

Throughout the present specification, “A and/or B” or “A or B” means A, B, or both A and B, e.g., “or” is not necessarily an exclusive term.

“Thickness” may be measured through a photograph taken with an optical microscope such as a scanning electron microscope.

As used herein, when a definition is not otherwise provided, the particle diameter may be an average particle diameter. The average particle diameter may mean the diameter (D₅₀) of particles having a cumulative volume of about 50 volume % in the particle size distribution. When the particle diameter is spherical, the diameter represents the particle diameter or average particle diameter, and when the particle diameter is not spherical, the diameter may be a major axis length or an average major axis length. The average particle diameter (D₅₀) may be measured by a method well known to those skilled in the art, and for example, may be measured by a particle size analyzer, or may be measured by a transmission electron microscopy, a scanning electron microscopy, or field emission scanning electron microscopy. Alternatively, a dynamic light-scattering measurement device is used to perform a data analysis, and the number of particles is counted for each particle size range. From this, the average particle diameter (D₅₀) value may be easily obtained through a calculation. It may be measured using a laser diffraction method. When measured in the laser diffraction method, specifically, after dispersing the particles to be measured in a dispersion medium, a commercially available laser diffraction particle diameter-measuring device (e.g., MT 3000, Microtrac Retsch GmbH) is introduced to irradiate them with an ultrasonic wave of about 28 kHz with an output of 60 W, obtaining the average particle diameter (D50) at 50% of a particle diameter distribution in the measuring device.

“Active mass” means a solid mixture of an active material, a binder and, optionally, a conductive material. For example, the active mass means an active material layer.

A negative active material according to some embodiments may include a core including a carbon material and a metal carbide on a surface of the core. In an implementation, the metal may be or include, e.g., Ti, Mo, Fe, Nb, Ta, W, or V.

In an implementation, the metal carbide may be represented by, e.g., Chemical Formula 1.

MₓC_{y} [Chemical Formula 1]

In Chemical Formula 1, 1≤x≤2, 1≤y≤3.

M may be, e.g., Ti, Mo, Fe, Nb, Ta, W, or V. In an implementation, the M may be, e.g., Ti, Nb, Ta, Mo, or a combination thereof.

In an implementation, the metal carbide may be, e.g., TiC, Mo₂C, Fe₂C, NbC, TaC, WC, VC, or a combination thereof.

The metal carbide may help promote a lithium ion intercalation reaction and may serve as a transport pathway for lithium ions. In an implementation, the metal carbide may be on the surface of the carbon material core, and the lithium transport pathway promoting the intercalation reaction of the lithium ions during the charging and discharging, through which the lithium ions may be rapidly inserted into the carbon material core, may be formed.

The metal carbide may help reduce interface resistance occurring on the surface of the carbon material core. A carbon material may have large interface resistance on the surface, and lithium ions may be slowly inserted, causing precipitation of a lithium metal on the surface. In an implementation, the metal carbide may help reduce the interface resistance and thus address the issue of the lithium metal precipitation. The deterioration of high-rate charging characteristics and cycle-life characteristics due to this precipitation may be effectively prevented. Resultantly, the negative active material according to some embodiments may exhibit improved high-rate charging characteristics and cycle-life characteristics.

This effect may be obtained by a metal carbide containing both a metal represented by M in the above formula and carbon. If metal oxides (MOₓ) or metal chalcogen (MSₓ, MSeₓ) compounds were to be used, rather than the metal carbide, or carbides of metals other than M (defined above) were to be used, the aforementioned effect may not be achieved, because a chemical composition thereof may be changed due to a conversion reaction with the lithium ions during the initial charge.

Some embodiments do not limit a shape that the metal carbide is located on the core surface. In an implementation, the metal carbide may be in a layer form in which the metal carbides may be continuously present or an island form in which the metal carbides may be discontinuously present.

In an implementation, an amount of the metal carbide may be, e.g., about 0.5 wt % to about 20 wt %, about 0.5 wt % to about 10 wt %, or about 1 wt % to about 5 wt %, based on a total weight of the negative active material. If the amount of the metal carbide is within the above ranges, better rapid charge/discharge characteristics and cycle-life characteristics may be exhibited.

In an implementation, the carbon material included in the core may include, e.g., crystalline carbon, amorphous carbon, or a combination thereof. In an implementation, the carbon material may be crystalline carbon. The crystalline carbon may include, e.g., unspecified shape, plate, flake, spherical or fibrous natural graphite, artificial graphite, or a combination thereof. In an implementation, the amorphous carbon may include, e.g., soft carbon, hard carbon, a mesophase pitch carbonized product, sintered cokes, or a combination thereof.

In an implementation, an amount of the core may be, e.g., about 80 wt % to about 99.5 wt % or about 90 wt % to about 99.5 wt %, based on the total weight of the negative active material. In an implementation, the core may be made of a carbon material, and the amount of the core means the amount of the carbon material.

In an implementation, the carbon material may have a particle diameter, e.g., an average particle diameter (D50) of about 3 μm to about 20 μm or about 5 μm to about 15 μm. If the carbon material has a particle diameter within the ranges, there may be an advantage of shortening the pathway of transporting the lithium ions inside the carbon material and between themselves. In an implementation, the core may be formed of the carbon material, which has a particle diameter within the ranges, and the core also may have a particle diameter within the ranges.

In an implementation, the metal carbide may be, e.g., coated on the surface of the carbon material, which may be confirmed through an X-ray diffraction spectroscopy analysis. In an implementation, the negative active material according to some embodiments, if analyzed through the X-ray diffraction spectroscopy, may exhibit a peak corresponding to the metal carbide. In an implementation, the peak may appear at about 35° to about 37°, about 41° to about 43°, and about 60° to about 62°, which may confirm that TiC is present on the surface.

In an implementation, the metal carbide on the surface of the carbon-material may be confirmed through a TEM photograph and, e.g., a FFT result of HRTEM. In an implementation, in the FFT result, if an interplanar distance appears about 0.20 nm to about 0.22 nm or about 0.24 nm to about 0.26 nm, the interplanar distance may correspond to TiC (200) and TiC (111), which may confirm that TiC is present on the surface. In an implementation, the metal carbide on the surface of the carbon material may be confirmed by an SEM photograph or an EDS (energy dispersive spectroscopy) result.

The negative active material according to some embodiments may be used as a negative active material for a rechargeable lithium battery.

The negative active material according to some embodiments may be prepared by mixing the carbon material and the carbon precursor in a solvent to prepare a primary mixture; mixing the primary mixture and a metal precursor to prepare a secondary mixture; and heat-treating the secondary mixture. Hereinafter, each process will be described in detail.

The carbon material and the carbon precursor may be primarily mixed in the solvent, preparing the primary mixture. Herein, the carbon precursor may be first added to the solvent, and then, the carbon material may be added thereto.

The carbon precursor, which is a material facilitating use of the metal precursor added after the carbon material, may form carbon during a subsequent firing process. The carbon precursor may include, e.g., glucose, sucrose, polyvinylpyrrolidone, polyvinyl alcohol, polyethylene, or a combination thereof.

The solvent may include, e.g., water, alcohol, or a combination thereof. The alcohol may include, e.g., methanol, ethanol, propanol, or a combination thereof.

The carbon precursor may be used in an amount of, e.g., about 0.1 wt % to about 5 wt % or about 0.5 wt % to about 3 wt %, based on 100 wt % of the carbon material. If the carbon precursor is used within the ranges, there may be an advantage of securing structural stability of a metal carbide produced therefrom.

The primary mixing process may be performed at about 50 rpm to about 500 rpm or about 100 rpm to about 300 rpm. If the primary mixing process is performed at the speeds, there may be an advantage of uniformly dispersing the precursors. The primary mixing process may be performed for about 0.5 hours to about 3 hours or for about 1 hour to about 3 hours.

After performing the primary mixing process, a pulverizing process may be further performed after removing the solvent. The solvent removing process may be performed through a drying process, e.g., at about 50° C. to about 100° C. or about 70° C. to about 90° C. In an implementation, the pulverizing process may be performed by using a ball mill.

The primary mixture and the metal precursor may be secondarily mixed to prepare the secondary mixture.

The metal precursor may include, e.g., metal alkoxide, metal acetate, metal hydroxide, or a combination thereof. The alkoxide may include, e.g., a methoxide, ethoxide, propoxide, butoxide, or a combination thereof.

The metal precursor may be in a solid state or in a metal liquid state added to a solvent. The solvent may include, e.g., anhydrous ethanol, anhydrous methanol, anhydrous propanol, or a combination thereof. If the metal precursor is used in the metal liquid state, the metal liquid may be prepared by adding the metal precursor to the solvent and stirring the mixture at about 50 rpm to about 500 rpm or about 100 rpm to about 300 rpm for about 0.5 hours to about 3 hours, or for about 1 hour to about 3 hours. In an implementation, a commercially available liquid metal precursor may be used.

In an implementation, the metal precursor and the carbon precursor may be used in a weight ratio of about 0.1:1 to about 3:1, e.g., about 0.5:1 to about 2:1. If the metal precursors are used within the ranges, the metal carbide may be uniformly on the core surface.

The secondary mixing process may be performed for about 0.5 hours to about 3 hours or for about 1 hour to about 3 hours.

After the secondary mixing process, a process of removing the solvent may be further performed. The solvent removing process may be performed through a drying process, e.g., at about 50° C. to about 100° C. or about 70° C. to about 90° C. In an implementation, the pulverizing process may be performed by using a ball mill.

The secondary mixture may be subjected to heat-treating process to prepare an anode active material.

The heat-treating process may be performed at about 500° C. to about 1,400° C., e.g., about 700° C. to about 1,300° C. The heat-treating process may be performed, after heating up to the temperature at about 1° C./min to about 10° C./min, at the temperature.

The heat-treating process may be performed for about 1 hour to about 10 hours or about 2 hours to about 7 hours. In an implementation, the heat-treating process may be performed under an atmosphere of nitrogen (N₂) gas, argon (Ar) gas, or a combination thereof.

Some embodiments provide a rechargeable lithium battery including a negative electrode, a positive electrode, and an electrolyte. The negative electrode may include a negative electrode current collector and a negative active material layer on at least one surface of the negative electrode current collector. The negative active material layer may include the negative active material according to some embodiments. In an implementation, as the negative active material, the negative active material according to some embodiments may be included as a first active material, and a silicon negative active material may be included as a second active material. A mixing (e.g., weight) ratio of the first negative active material and the second negative active material may be about 99:1 to about 50:50, or about 95:5 to about 80:20.

The silicon active material may include, e.g., Si, a Si—C composite, SiOₓ (0<x<2), a Si-Q alloy (wherein Q is an alkali metal, an alkaline earth metal, a Group 13 element, a Group 14 element, a Group 15 element, a Group 16 element, a transition metal, a rare earth element, or a combination thereof, but not Si), and the like, and a mixture of at least one of these elements and SiO₂ may be used. The element Q may be, e.g., Mg, Ca, Sr, Ba, Ra, Sc, Y, Ti, Zr, Hf, Rf, V, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

In an implementation, the Si—C composite may be a form of silicon particles and amorphous carbon coated on the surface of the silicon particles. In an implementation, the silicon-carbon composite may include secondary particles into which primary silicon particles are assembled and an amorphous carbon coating layer on the surface of the secondary particles. The amorphous carbon may be, e.g., coated between the silicon primary particles. In an implementation, the silicon-carbon composite may include a core that the silicon particles are dispersed in an amorphous carbon matrix and an amorphous carbon coating layer coated on the surface of the core.

The secondary particles may be located in the center of the Si—C composite, which may be referred to as the core and a center portion. In an implementation, the amorphous carbon coating layer may be referred to as a shell or an outer portion.

The silicon particles may be silicon nanoparticles. The silicon nanoparticles may have a particle diameter of about 10 nm to 1,000 nm, e.g., about 20 nm to about 900 nm, about 20 nm to about 800 nm, about 20 nm to about 500 nm, about 20 nm to about 300 nm, or 20 nm to 150 nm. If the average particle diameter of the silicon particles is within the above ranges, excessive volume expansion occurring during charging and discharging may be suppressed, and disconnection of a conductive path due to particle crushing during charging and discharging may be prevented.

In an implementation, a mixing (e.g., weight) ratio of nano silicon and amorphous carbon may be about 20:80 to about 70:30.

In an implementation, the secondary particle or the core may further include crystalline carbon. If the silicon-carbon composite further includes crystalline carbon, the Si—C composite may include secondary particles in which primary silicon particles and crystalline carbon are assembled, and an amorphous carbon coating layer on the surface of the secondary particles.

In an implementation, if Si—C includes silicon particles, crystalline carbon, and amorphous carbon, an amount of the amorphous carbon may be about 30 wt % to about 70 wt % based on 100 wt % of the total Si—C composite, and an amount of the crystalline carbon may be about 1 wt % to about 20 wt % based on 100 wt % of the total Si—C composite. In an implementation, the amount of the silicon particles may be about 20 wt % to about 69 wt % based on 100 wt % of the total Si—C composite, e.g., about 30 wt % to about 60 wt %.

A particle diameter of the Si—C composite may be suitably adjusted.

If the amorphous carbon is disposed while surrounding the secondary surface, its thickness may be appropriately adjusted, e.g., at about 5 nm to about 100 nm.

In the negative active material layer, an amount of the negative active material may be about 95 wt % to about 99 wt % based on a total weight of the negative active material layer.

In an implementation, the negative active material layer may include a binder or a conductive material. In the negative active material layer, an amount of the binder may be about 1 wt % to about 5 wt % based on a total weight of the negative active material layer. If the negative active material layer includes a conductive material, the negative active material layer may include about 90 wt % to about 98 wt % of the negative active material, about 1 wt % to about 5 wt % of the binder, and about 1 wt % to about 5 wt % of the conductive material.

The binder may help improve binding properties of negative active material particles with one another and with a current collector. The binder may include a non-aqueous binder, an aqueous binder, or a combination thereof.

The non-aqueous binder may include, e.g., ethylenepropylene copolymer, polyacrylonitrile, polystyrene, polyvinylchloride, carboxylated polyvinylchloride, polyvinyl fluoride, polyurethane, polytetrafluoroethylene, polyvinylidene fluoride, polyethylene, polypropylene, polyamideimide, polyimide, or a combination thereof.

The aqueous binder may include, e.g., a styrene-butadiene rubber (SBR), an acrylated styrene-butadiene rubber (ABR), an acrylonitrile-butadiene rubber, an acrylic rubber, a butyl rubber, a fluorine rubber, an ethylene oxide-containing polymer, polyvinylpyrrolidone, polyepichlorohydrine, polyphosphazene, an ethylenepropylenediene copolymer, polyvinylpyridine, chlorosulfonatedpolyethylene, latex, a polyester resin, an acrylic resin, a phenolic resin, an epoxy resin, polyvinyl alcohol, or a combination thereof.

If the aqueous binder is used as a negative electrode binder, a cellulose compound may be further used to provide viscosity. The cellulose compound may include, e.g., carboxymethyl cellulose, hydroxypropylmethyl cellulose, methyl cellulose, or alkali metal salts thereof. The alkali metal may be, e.g., Na, K, or Li. The cellulose compound may impart viscosity, and it may be referred to a thickener. The cellulose compound may also serve as a binder, and it may be referred to a binder. An amount of the cellulose compound may be appropriately adjusted, e.g., an amount of the cellulose compound may be about 0.1 part by weight to about 3 parts by weight based on 100 parts by weight of the negative active material.

The conductive material may be included to provide electrode conductivity and a suitable electrically conductive material that does not cause a chemical change may be used. Examples of the conductive material may include a carbon material such as natural graphite, artificial graphite, carbon black, acetylene black, ketjen black, channel black, furnace black, lamp black, thermal black, carbon fiber, or the like; a metal material of a metal powder or a metal fiber including copper, nickel, aluminum silver, or the like; a conductive polymer such as a polyphenylene derivative; or a mixture thereof.

The negative current collector may include, e.g., a copper foil, a nickel foil, a stainless steel foil, a titanium foil, a nickel foam, a copper foam, a polymer substrate coated with a conductive metal, or a combination thereof.

The positive electrode may include a positive current collector and a positive active material layer formed on the positive current collector.

The positive active material may include lithiated intercalation compounds that reversibly intercalate and deintercalate lithium ions. In an implementation, one or more composite oxides of a metal selected from cobalt, manganese, nickel, and a combination thereof, and lithium may be used. In an implementation, a compound represented by one of the following chemical formulas may be used. LiₐA_{1-b}X_{b}D¹₂ (0.90≤a≤1.8, 0≤b≤0.5); LiₐA_{1-b}X_{b}O_{2-c1}D¹_{c1} (0.90≤a≤1.8, 0≤b≤0.5, 0≤c1≤0.05); LiₐE_{1-b}X_{b}O_{2-c1}D¹_{c1} (0.90≤a≤1.8, 0≤b≤0.5, 0≤c1≤0.05); LiₐE_{2-b}X_{b}O_{4-c1}D¹_{c1} (0.90≤a≤1.8, 0≤b≤0.5, 0≤c1≤0.05); LiₐNi_{1-b-c}Co_{b}X_{c}D¹_{α} (0.90≤a≤1.8, 0≤b≤0.5, 0≤c≤0.5, 0≤α≤2); LiₐNi_{1-b-c}Co_{b}X_{c}O_{2-α}T_{α} (0.90≤a≤1.8, 0≤b≤0.5, 0≤c≤0.5, 0≤α≤2); LiₐNi_{1-b-c}Co_{b}X_{c}O_{2-α}T₂ (0.90≤a≤1.8, 0≤b≤0.5, 0≤c≤0.5, 0≤α≤2); LiₐNi_{1-b-c}Mn_{b}X_{c}D¹_{α} (0.90≤a≤1.8, 0≤b≤0.5, 0≤c≤0.5, 0≤a≤2); LiₐNi_{1-b-c}Mn_{b}X_{c}O_{2-α}T_{α} (0.90≤a≤1.8, 0≤b≤0.5, 0≤c≤0.5, 0≤α≤2); LiₐNi_{1-b-c}Mn_{b}X_{c}O_{2-α}T₂ (0.90≤a≤1.8, 0≤b≤0.5, 0≤c≤0.5, 0≤a≤2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂GbO₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃(0≤f≤2); and LiₐFePO₄(0.90≤a≤1.8)

In the above chemical formulas, A may be, e.g., Ni, Co, Mn, or a combination thereof, X may be, e.g., Al, Ni, Co, Mn, Cr, Fe, Mg, Sr, V, a rare earth element, or a combination thereof, D¹ may be, e.g., O, F, S, P, or a combination thereof, E may be, e.g., Co, Mn, or a combination thereof; T may be, e.g., F, S, P, or a combination thereof; G may be, e.g., Al, Cr, Mn, Fe, Mg, La, Ce, Sr, V, or a combination thereof, Q may be, e.g., Ti, Mo, Mn, and a combination thereof, Z may be, e.g., Cr, V, Fe, Sc, Y, or a combination thereof, J may be, e.g., V, Cr, Mn, Co, Ni, Cu, or a combination thereof, and L¹ may be, e.g., Mn, Al, or a combination thereof.

The compounds may have a coating layer on the surface, or may be mixed with another compound having a coating layer. The coating layer may include a coating element compound, e.g., an oxide of a coating element, a hydroxide of a coating element, an oxyhydroxide of a coating element, an oxycarbonate of a coating element, or a hydroxy carbonate of a coating element. The compound for the coating layer may be amorphous or crystalline. The coating element include, e.g., Mg, Al, Co, K, Na, Ca, Si, Ti, V, Sn, Ge, Ga, B, As, Zr, or a mixture thereof. The coating layer may be formed in a method having no adverse influence on properties of a positive active material by using these elements in the compound. In an implementation, the method may include a suitable coating method (e.g., spray coating, dipping, or the like).

In the positive active material layer, an amount of the positive active material may be about 90 wt % to about 98 wt %, based on the total weight of the positive active material layer.

The positive active material layer may include a binder and a conductive material. In an implementation, the amount of the binder and the conductive material may be about 1 wt % to about 5 wt %, respectively, based on a total weight of the positive active material layer.

The binder may serve to well attach the positive active material particles to each other and also to well attach the positive active material to the current collector. Examples thereof may include polyvinyl alcohol, carboxymethyl cellulose, hydroxypropyl cellulose, diacetyl cellulose, polyvinylchloride, carboxylated polyvinylchloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like.

The conductive material may impart conductivity to the electrode, and a suitable material that does not cause a chemical change in the battery may be used, e.g., an electron conductive material. Examples of the conductive material may include a carbon material such as natural graphite, artificial graphite, carbon black, acetylene black, ketjen black, a carbon fiber, or the like; a metal material of a metal powder or a metal fiber including copper, nickel, aluminum, silver, or the like; a conductive polymer such as a polyphenylene derivative; or a mixture thereof.

The current collector may include, e.g., Al.

The negative electrode and the positive electrode may be manufactured by mixing an active material, a conductive material, and a binder in a solvent to prepare an active material composition, and applying the composition to a current collector. The solvent may include, e.g., N-methyl pyrrolidone or the like. In an implementation, if an aqueous binder is used for the negative electrode, water may be used as a solvent used in preparing the negative active material composition.

The electrolyte may include a non-aqueous organic solvent and a lithium salt.

The non-aqueous organic solvent may serve as a medium for transmitting ions taking part in the electrochemical reaction of a battery.

The non-aqueous organic solvent may include a carbonate, ester, ether, ketone, alcohol, or aprotic solvent.

The carbonate solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester solvent may include methyl acetate, ethyl acetate, n-propyl acetate, dimethylacetate, methylpropionate, ethylpropionate, γ-butyrolactone, decanolide, valerolactone, mevalonolactone, caprolactone, or the like. The ether solvent may include dibutyl ether, tetraglyme, diglyme, dimethoxyethane, 2-methyltetrahydrofuran, 2,5-dimethyltetrahydrofuran, tetrahydrofuran, or the like. The ketone solvent may include cyclohexanone, or the like. The alcohol solvent may include ethanol, isopropyl alcohol, or the like. The aprotic solvent may include nitriles such as R—CN (where R is a C2 to C20 linear, branched, or cyclic hydrocarbon, may include a double bond, an aromatic ring, or an ether bond), amides such as dimethylformamide, dioxolanes such as 1,3-dioxolane, 1,4-dioxolane, sulfolanes, or the like.

The non-aqueous organic solvent may be used alone or in a mixture of one or more. If the organic solvent is used in a mixture, the mixture ratio may be controlled in accordance with a desirable battery performance.

If the non-aqueous organic solvent is mixed and used, a mixed solvent of a cyclic carbonate and a chain carbonate, a mixed solvent of a cyclic carbonate and a propionate solvent, or a mixed solvent of a cyclic carbonate, a chain carbonate, and a propionate solvent may be used. The propionate solvent may include methyl propionate, ethyl propionate, propyl propionate, or a combination thereof.

If the cyclic carbonate and the chain carbonate or the cyclic carbonate and the propionate solvent are mixed, they may be mixed in a volume ratio of about 1:1 to about 1:9 and thus performance of an electrolyte solution may be improved. In an implementation, if the cyclic carbonate, the chain carbonate, and the propionate solvent are mixed, they may be mixed in a volume ratio of about 1:1:1 to about 3:3:4. The mixing ratios of the solvents may be appropriately adjusted according to desirable properties.

The non-aqueous organic solvent may further include an aromatic hydrocarbon organic solvent in addition to the carbonate solvent. In an implementation, the carbonate solvent and the aromatic hydrocarbon organic solvent may be mixed in a volume ratio of about 1:1 to about 30:1.

The aromatic hydrocarbon organic solvent may include, e.g., an aromatic hydrocarbon compound of Chemical Formula 2.

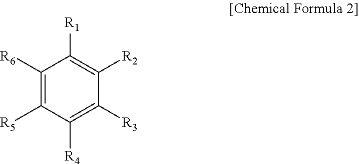

In Chemical Formula 2, R₁ to R₆ may each independently be or include, e.g., hydrogen, a halogen, a C1 to C10 alkyl group, a haloalkyl group, or a combination thereof.

In an implementation, the aromatic hydrocarbon organic solvent may include, e.g., benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

In an implementation, the electrolyte may further include an additive, e.g., vinylethyl carbonate, vinylene carbonate, or an ethylene carbonate compound of Chemical Formula 3, in order to help improve a cycle-life of a battery.

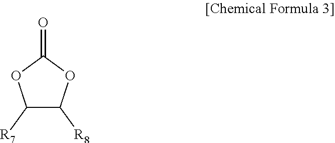

In Chemical Formula 3, R₇ and R₈ may each independently be or include, e.g., hydrogen, a halogen, a cyano group (CN), a nitro group (NO₂), or a fluorinated C1 to C5 alkyl group. In an implementation, at least one of R₇ and R₈ may be, e.g., a halogen, a cyano group (CN), a nitro group (NO₂), or a fluorinated C1 to C5 alkyl group, and R₇ and R₈ may not both be hydrogen.

Examples of the ethylene carbonate compound may include difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving a cycle-life may be used within an appropriate range.

The lithium salt dissolved in an organic solvent may supply a battery with lithium ions, basically operates the rechargeable lithium battery, and improves transportation of the lithium ions between positive and negative electrodes. Examples of the lithium salt include LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein, x and y are natural numbers, e.g., an integer ranging from 1 to 20, lithium difluoro(bisoxolato) phosphate, LiCl, LiI, LiB(C₂O₄)₂ (lithium bis(oxalato) borate: LiBOB), and lithium difluoro(oxalato)borate (LiDFOB). A concentration of the lithium salt may range from about 0.1 M to about 2.0 M. If the lithium salt is included at the above concentration range, an electrolyte may have excellent performance and lithium ion mobility due to optimal electrolyte conductivity and viscosity.

The rechargeable lithium battery may further include a separator between the negative electrode and the positive electrode, depending on a kind of the battery. Examples of a suitable separator material may include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

In an implementation, the separator may include the film as a substrate and may further include a coating layer on at least one surface of the film.

The coating layer may include ceramic. The ceramic may include, e.g., SiO₂, Al₂O₃, Al(OH)₃, AlO(OH), TiO₂, BaTiO₂, ZnO₂, Mg(OH)₂, MgO, Ti(OH)₄, ZrO₂, aluminum nitride, silicon carbide, boron nitride, or a combination thereof.

The coating layer may be a functional layer capable of adding additional functions. This functional layer may be, e.g., a heat resistant layer or an adhesive layer. The heat resistant layer may include a heat resistant resin and optionally a filler. In an implementation, the adhesive layer may include an adhesive resin and optionally a filler. The filler may be an organic filler, an inorganic filler, or a combination thereof. A suitable heat resistant resin, adhesive resin, or filler that are usable for separators may be used.

The rechargeable lithium battery may be classified into, e.g., a lithium ion battery, a lithium ion polymer battery, and a lithium polymer battery depending on kinds of a separator and an electrolyte. It may be classified to be cylindrical, prismatic, coin-type, pouch-type, and the like depending on a shape. In an implementation, it may be bulk type and thin film type depending on sizes.

The FIGURE is an exploded perspective view of a rechargeable lithium battery according to some embodiments. As illustrated in the FIGURE, the rechargeable lithium battery may be a prismatic battery, or the battery may include variously-shaped batteries such as a cylindrical battery, a pouch battery, or the like.

Referring to the FIGURE, a rechargeable lithium battery 100 according to some embodiments may include an electrode assembly 40 manufactured by winding a separator 30 between a positive electrode 10 and a negative electrode 20, and a case 50 housing the electrode assembly 40. An electrolyte may be impregnated in the positive electrode 10, the negative electrode 20, and the separator 30.

Hereinafter, examples and comparative examples are described. These examples, however, are not in any sense to be interpreted as limiting the scope of the embodiments.

### Comparative Example 1

Artificial graphite with an average particle diameter of 12 μm was used as a negative active material.

The negative active material, a styrene-butadiene rubber, and carboxymethyl cellulose in a weight ratio of 96:2:2 were mixed in a distilled water solvent, preparing a negative active material slurry. This negative active material slurry was coated on a 75 m-thick copper current collector and then, dried at 80° C. and roll-pressed. Subsequently, a product therefrom was dried at 80° C. for 12 hours, manufacturing a negative electrode. The negative electrode had a loading level of 7.5 mg/cm² and an active mass density of 1.5 g/cc.

The negative electrode, a lithium metal counter electrode, and an electrolyte were used to fabricate a coin-type half-cell. The electrolyte was prepared by forming a 1 M LiPF₆ solution in a mixed solvent of ethylene carbonate and dimethyl carbonate (in a volume ratio of 3:7).

### Example 1

Glucose was added to distilled water and then, stirred at 300 rpm for 1 hour. Subsequently, artificial graphite was added to the stirred product, preparing a primary mixture. Herein, the glucose was used in an amount of 0.66 wt % based on 100 wt % of the artificial graphite.

The primary mixture was dried at 80° C. and after removing the distilled water, pulverized.

Ti(OC₄H₉)₄ was added to anhydrous ethanol and then, stirred at 300 rpm for 1 hour at ambient temperature, preparing a metal solution.

The primary mixture and the metal solution were mixed and stirred for 1 hour to have a weight ratio of 2:1 between the glucose and the Ti(OC₄H₉)₄, preparing a secondary mixture. Subsequently, the secondary mixture was dried at 80° C. to remove the anhydrous ethanol.

Then, a dried product therefrom was put in a firing furnace, heated up to 1,200° C. at 5° C./min and heat-treated at 1,200° C. for 4 hours under an argon atmosphere, preparing a negative active material. The prepared negative active material included an artificial graphite core and TiC on the surface of the artificial graphite. An amount of TiC was 1 wt %, based on the total weight of the negative active material.

A negative electrode and a half-cell were manufactured in the same manner as in Comparative Example 1 except that the negative active material was used.

### Example 2

A negative active material was prepared in the same manner as in Example 1 except that the amount of the glucose was changed from 0.66 wt % to 1.33 wt % based on 100 wt % of the artificial graphite. The prepared negative active material included the artificial graphite and TiC on the surface of the artificial graphite, and an amount of TiC was 2 wt % based on the total weight of the negative active material.

A negative electrode and a half-cell were manufactured in the same manner as in Comparative Example 1 except that the negative active material was used.

### Example 3

A negative active material was prepared in the same manner as in Example 1 except that the amount of the glucose was changed from 0.66 wt % to 3.33 wt % based on 100 wt % of the artificial graphite. The prepared negative active material included the artificial graphite and TiC on the surface of the artificial graphite, and an amount of TiC was 5 wt % based on the total weight of the negative active material.

A negative electrode and a half-cell were manufactured in the same manner as in Comparative Example 1 except that the negative active material was used.

### Example 4

A negative active material was prepared in the same manner as in Example 1 except that the amount of the glucose was changed from 0.66 wt % to 0.33 wt % based on 100 wt % of the artificial graphite. The prepared negative active material included the artificial graphite and TiC on the surface of the artificial graphite, and an amount of TiC was 0.5 wt % based on the total weight of the negative active material.

A negative electrode and a half-cell were manufactured in the same manner as in Comparative Example 1 except that the negative active material was used.

### Example 5

A negative active material was prepared in the same manner as in Example 1 except that the amount of the glucose was changed from 0.66 wt % to 13.3 wt % based on 100 wt % of the artificial graphite. The prepared negative active material included the artificial graphite and TiC on the surface of the artificial graphite, and an amount of TiC was 20 wt % based on the total weight of the negative active material.

A negative electrode and a half-cell were manufactured in the same manner as in Comparative Example 1 except that the negative active material was used.

### Example 6

A negative active material was prepared in the same manner as in Example 1 except that Nb₂(OC₂H₅)₁₀ was used instead of Ti(OC₄H₉)₄. The prepared negative active material included the artificial graphite and NbC on the surface of the artificial graphite, and an amount of NbC was 2 wt % based on the total weight of the negative active material.

A negative electrode and a half-cell were manufactured in the same manner as in Example 1 except that the negative active material was used.

### Comparative Example 2

Ti(OC₄H₉)₄ was added to anhydrous ethanol and then, stirred at 300 rpm for 1 hour at ambient temperature, preparing a metal solution.

The metal solution was mixed with artificial graphite for 1 hour in a weight ratio of 8:92 between Ti(OC₄H₉)₄ and artificial graphite, preparing a mixture. The mixture was dried at 80° C. to remove the anhydrous ethanol.

Subsequently, a dried product therefrom was put in a firing furnace and heated at 5° C./min up to 1,200° C. and heat-treated at 1,200° C. for 4 hours under an argon atmosphere, preparing a negative active material. The prepared negative active material included an artificial graphite core and TiO₂ on the surface of the artificial graphite, and an amount of TiO₂ was 2 wt % based on the total weight of the negative active material.

A negative electrode and a half-cell were manufactured in the same manner as in Comparative Example 1 except that the negative active material was used.

A negative electrode and a half-cell were manufactured in the same manner as in Comparative Example 1 except that the negative active material was used.

### Experimental Example 1: Evaluation of High Rate Charging

Each of the half cells of Examples 1 to 6 and Comparative Example 1 was charged and discharged within a voltage range of 0.01 V to 1.5 V vs. Li/Li⁺ under the following conditions.
1 C charge/0.5 C discharge, once
2 C charge/0.5 C discharge, once
3 C charge/0.5 C discharge, once
4 C charge/0.5 C discharge, once
5 C charge/0.5 C discharge, once
6 C charge/0.5 C discharge, once
2 C charge/0.2 C discharge, once

A ratio of charge capacity at each C-rate to charge capacity at 1 C was calculated. The results are shown as a high-rate charging rate in Table 1.

TABLE 1

| | 2 C | 3 C | 4 C | 5 C | 6 C |
|---|---|---|---|---|---|
| | charging | charging | charging | charging | charging |
| | rate (%) | rate (%) | rate (%) | rate (%) | rate (%) |
| Example 1 | 56.0 | 23.2 | 13.0 | 6.5 | 4.9 |
| Example 2 | 62.7 | 28.9 | 14.1 | 7.6 | 4.9 |
| Example 3 | 53.7 | 23.3 | 13.4 | 6.5 | 4.9 |
| Example 4 | 49.9 | 22.4 | 12.8 | 6.2 | 4.5 |
| Example 5 | 47.8 | 21.1 | 12.1 | 5.8 | 4.3 |
| Example 6 | 50.7 | 23.2 | 13.1 | 6.3 | 4.7 |
| Comparative | 45.5 | 19.4 | 10.1 | 5.2 | 3.9 |
| Example 1 | | | | | |
| Comparative | 45.8 | 18.8 | 11.1 | 5.6 | 3.9 |
| Example 3 | | | | | |

As shown in Table 1, the cells of Examples 1 to 6 (including a negative active material having an artificial graphite core and TiC or NbC on the core surface) exhibited excellent high-rate charging rate at 2 C to 6 C, compared with the cell of Comparative Example 1 including a negative active material of the artificial graphite alone.

In Comparative Example 2, a negative active material having TiO₂ on the surface of an artificial graphite core was included, and the result was similar or inferior to that of Comparative Example 1.

### Experimental Example 2: Evaluation of High Rate Capability

Each of the half cells of Examples 1 to 6 and Comparative Examples 1 and 2 was charged once at 0.2 C/discharged at 0.2 C, charged once at 2 C/discharged at 2 C, and charged once at 3 C/discharged at 3 C within the voltage range of 0.01 V to 1.5 V vs. Li/Li⁺. Herein, the charging was performed under a constant current (CC) and a constant voltage (CV).

Each charge capacity at 0.2 C, 2 C, and 3 C was measured. The results are shown in Table 2.

In addition, a ratio of charge capacity at 2 C to charge capacity at 0.2 C and also, a ratio of charge capacity at 3 C to charge capacity at 0.2 C were calculated. The results are shown in Table 2.

TABLE 2

| | 0.2 C | 2 C | 3 C | 2 C/ | 3 C/ |
|---|---|---|---|---|---|
| | (mAh/ | (mAh/ | (mAh/ | 0.2 C | 0.2 C |
| | g) | g) | g) | (%) | (%) |
| Example 1 | 340.9 | 190.9 | 79.1 | 56.0 | 23.2 |
| Example 2 | 343.0 | 215.1 | 99.1 | 62.7 | 28.9 |
| Example 3 | 341.5 | 183.4 | 79.6 | 53.7 | 23.3 |
| Example 4 | 340.1 | 169.7 | 76.2 | 49.9 | 22.4 |
| Example 5 | 335.4 | 162.0 | 70.0 | 48.8 | 20.1 |
| Example 6 | 340.9 | 171.3 | 77.5 | 51.7 | 22.9 |
| Comparative Example 1 | 333.3 | 158.6 | 66.0 | 43.7 | 19.4 |
| Comparative Example 2 | 331.4 | 151.8 | 62.3 | 45.8 | 18.8 |

In Table 2, Examples 1 to 5 (including a negative active material having an artificial graphite core and TiC or NbC on the core surface) exhibited excellent high-rate charge and discharge characteristics, compared with Comparative Example 1 including a negative active material of the artificial graphite alone.

In Comparative Example 2, the negative active material having TiO₂ on the surface of an artificial graphite core was included, and the result was similar to or inferior to that of Comparative Example 1.

### Experimental Example 3: Impedance Evaluation

The half cells of Examples 1 to 6 and Comparative Examples 1 and 2 were charged once at 0.05 C/discharged at 0.05 C within a voltage range of 0.01 V to 1.5 V vs. Li/Li⁺ and then, charged at 0.05 C to SOC50 (a state of being charged to charge capacity of 50% based on 100% of total charge capacity and thus, discharged to 50%). The charged cells were measured with respect to impedance in an EIS (electrochemical impedance spectroscopy) method. The impedance was measured within a range of 0.5 mHz to 1 MHz. Table 3 shows the results of electrolyte internal resistance (bulk resistance (R_{b}), resistance due to an SEI layer formed in a negative electrode (R_{SEI}), and charge transfer resistance (R_{ct}).

TABLE 3

| | R_{b} (Ω) | R_{SEI} (Ω) | Rct (Ω) |
|---|---|---|---|
| Example 1 | 1.6 | 3.1 | 9.0 |
| Example 2 | 1.5 | 2.6 | 5.5 |
| Example 3 | 1.7 | 3.1 | 6.5 |
| Example 4 | 1.1 | 3.7 | 11.3 |
| Example 5 | 1.2 | 4.1 | 12.4 |
| Example 6 | 1.5 | 3.3 | 8.7 |
| Comparative Example 1 | 1.8 | 4.9 | 13.8 |
| Comparative Example 2 | 2.0 | 5.1 | 15.9 |

As shown in Table 3, the cells of Examples 1 to 6 (including a negative active material having an artificial graphite core and TiC or NbC on the core surface) exhibited very low resistance, compared with the cell of Comparative Example 1 including a negative active material of the artificial graphite alone.

In Comparative Example 2, a negative active material having TiO₂ on the artificial graphite core surface was included, and the resistance was similar to or higher than that of Comparative Example 1.

By way of summation and review, in order to increase a mileage of the electric vehicles, improving energy density of rechargeable lithium batteries has been considered. However, in order to widely spread the electric vehicles, their charging time should be shortened. Accordingly, rechargeable lithium batteries capable of rapid charging are being developed.

One or more embodiments may provide a negative active material with improved high rate charging and cycle-life characteristics.

The negative active material according to some embodiments may exhibit excellent high rate charging and cycle-life characteristics.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative active material, comprising:
a core including a carbon material; and
a metal carbide on a surface of the core,
wherein the metal of the metal carbide is Ti, Mo, Fe, Nb, Ta, W, or V.

2. The negative active material as claimed in claim 1, wherein:
the metal carbide is represented by Chemical Formula 1:
MₓC_{y} [Chemical Formula 1]
in Chemical Formula 1,
1≤x≤2 and 1≤y≤3, and
M is Ti, Mo, Fe, Nb, Ta, W, or V.

3. The negative active material as claimed in claim 1, wherein the metal carbide is TiC, Mo₂C, Fe₂C, NbC, TaC, WC, VC, or a combination thereof.

4. The negative active material as claimed in claim 1, wherein the metal carbide is included in the negative active material in an amount of about 0.5 wt % to about 20 wt %, based on a total weight of the negative active material.

5. The negative active material as claimed in claim 1, wherein the metal carbide is included in the negative active material in an amount of about 0.5 wt % to about 10 wt %, based on a total weight of the negative active material.

6. The negative active material as claimed in claim 1, wherein the core is included in the negative active material in an amount of about 80 wt % to about 99.5 wt %, based on a total weight of the negative active material.

7. The negative active material as claimed in claim 1, wherein the carbon material is crystalline carbon, amorphous carbon, or a combination thereof.

8. The negative active material as claimed in claim 1, wherein the carbon material is crystalline carbon.

9. The negative active material as claimed in claim 1, wherein the negative active material is prepared by:
mixing the carbon material and a carbon precursor in a solvent to prepare a primary mixture;
mixing the primary mixture and a metal precursor to prepare a secondary mixture; and
heat-treating the secondary mixture.

10. The negative active material as claimed in claim 9, wherein the carbon precursor is glucose, sucrose, polyvinylpyrrolidone, polyvinyl alcohol, polyethylene, or a combination thereof.

11. The negative active material as claimed in claim 9, wherein the metal precursor is a metal alkoxide, a metal acetate, a metal hydroxide, or a combination thereof.

12. The negative active material as claimed in claim 9, wherein the heat-treating is performed under an atmosphere of nitrogen gas, argon gas, or a combination thereof.

13. The negative active material as claimed in claim 9, wherein the heat-treating is performed at about 500° C. to about 1,400° C.

14. A rechargeable lithium battery, comprising:
a negative electrode including the negative active material as claimed in claim 1;
a positive electrode; and
an electrolyte.
